(19) United States
(12) Patent Application Publication
(10) Pub. No.: US 2025/0181031 A1
(43) Pub. Date: Jun. 5, 2025

(54) BRIDGE FOR GUIDING A BALANCE OF A TIMEPIECE

(71) Applicant: BULGARI HORLOGERIE SA, Neuchâtel (CH)

(72) Inventors: François Perez, Founex (CH); Alfredo De Biase, Le Sentier (CH)

(73) Assignee: BULGARI HORLOGERIE SA, Neuchâtel (CH)

(21) Appl. No.: 18/844,197

(22) PCT Filed: Mar. 8, 2023
(86) PCT No.: PCT/EP2023/055911

§ 371 Date: Sep. 5, 2024

(30) Foreign Application Priority Data
Mar. 8, 2022 (FR) FR2202010

(51) Int. Cl. G04B 17/32; G04B 17/06

(52) U.S. Cl. CPC G04B 17/32; G04B 17/063

(57) ABSTRACT

The guide element (1) for guiding the pivoting, about an axis (A), of a balance (91) of a timepiece (200), includes a first guide bearing (2) not fitted with a damper, and a first blank (3), in particular a first balance bridge or cock, the first blank (3) including at least a first fixing portion (31) for fixing to another blank (4), a first receiving portion (32) for receiving the first guide bearing (2), and at least a first flexible arm (33) mechanically connecting the first fixing portion (31) to the first receiving portion (32).

### TECHNICAL FIELD OF THE INVENTION

The invention relates to a guide element for guiding the pivoting of a balance wheel of a timepiece. The invention also relates to a timepiece module comprising such a guide element. The invention further relates to a timepiece movement comprising such a guide element or such a timepiece module. The invention lastly relates to a timepiece comprising such a guide element or such a timepiece movement or such a timepiece module.

### BACKGROUND ART

Mechanical timepiece movements usually make use of an oscillator of the balance wheel-hairspring type. The balance wheel is guided to pivot about an axis by virtue of bearings mounted in a frame of the movement. Conventionally, a first bearing is mounted in a plate of the movement via a first shock absorber and a second bearing is mounted in a balance bar via a second shock absorber. The shock absorbers make the mounting flexible so that the balance staff is not damaged when the movement experiences an impact, the balance wheel having considerable inertia and the balance staff needing to have pivots of reduced dimensions to optimize the range of the movement.

However, an architecture as described above has the drawback of being bulky in the direction of the pivot axis of the balance wheel, which is to say in general in the thickness of the timepiece movement. This is particularly disadvantageous for realizing an ultra-flat movement.

### SUMMARY OF THE INVENTION

The aim of the invention is to provide a guide element which overcomes the aforementioned drawbacks and improves on the guide elements known from the prior art. In particular, the invention proposes a simple guide element which is compact in the direction of the thickness of the timepiece movement.

According to the invention, an element makes it possible to guide the pivoting, about an axis, of a balance wheel of a timepiece. The element comprises:
a first guide bearing which does not have a shock absorber, and
a first blank, in particular a first balance bar or cock, the first blank comprising:
at least one first portion for fixing to another blank,
a first receiving portion for receiving the first guide bearing, and
at least one first flexible arm mechanically connecting the first fixing portion to the first receiving portion.

The at least one first arm may be configured and/or designed so as to define a stiffness of movement of the first receiving portion of about 8 N/mm or less than 10 N/mm or less than 20 N/mm or less than 50 N/mm or less than 100 N/mm along the direction of the axis and/or the at least one first arm may be configured and/or designed such that the first receiving portion can be moved by more than 0.05 mm or approximately 0.1 mm along the direction of the axis.

The guide element may comprise multiple first flexible arms, in particular 2, 3 or 4 first flexible arms, mechanically connecting the at least one first fixing portion to the first receiving portion.

The one or more first arms may comprise an open-worked geometry and/or the one or more first arms may extend substantially radially to the direction of the axis and/or each arm may comprise two parallel branches extending from the one or more first fixing portions and coming close to one another in the vicinity of the first receiving portion for receiving the guide bearing.

The first fixing portion may be in the form of a rim and/or the first receiving portion for receiving the first guide bearing may have a thickness of about 0.2 mm or less than 0.23 mm or less than 0.14 mm along the axis.

One of the at least one first arms may comprise a balance spring stud holder.

The first fixing portion may comprise a first receiving portion for receiving a first guide bearing for an escapement wheel.

The guide element may comprise:
a second guide bearing which does not have a shock absorber, and
a second blank, in particular a second balance bar or a plate, the second blank comprising:
at least one second portion for fixing to the first blank,
a second receiving portion for receiving the second guide bearing, and
at least one second flexible arm mechanically connecting the at least one second fixing portion to the second receiving portion.

The at least one second arm may be configured and/or designed so as to define a stiffness of movement of the second receiving portion of about 8 N/mm or less than 10 N/mm or less than 20 N/mm or less than 50 N/mm or less than 100 N/mm along the direction of the axis and/or the at least one second arm may be configured and/or designed such that the second receiving portion can be moved by more than 0.05 mm or approximately 0.1 mm along the direction of the axis.

The guide element may comprise multiple second flexible arms, in particular 2, 3 or 4 second flexible arms, mechanically connecting the at least one second fixing portion to the second receiving portion.

The one or more second arms may comprise an open-worked geometry and/or the one or more second arms may extend substantially radially to the direction of the axis and/or each arm may comprise two parallel branches extending from the one or more second fixing portions and coming close to one another in the vicinity of the second receiving portion for receiving the guide bearing.

The second fixing portion may be in the form of a rim and/or the second receiving portion for receiving the second guide bearing may have a thickness of about 0.2 mm or less than 0.23 mm or less than 0.14 mm along the axis.

One of the at least one second arms may comprise a balance spring stud holder.

The at least one second fixing portion may comprise a second receiving portion for receiving a guide bearing for an escapement wheel and/or the at least one second fixing portion may comprise a second receiving portion for receiving a guide bearing for a pallet assembly.

According to the invention, a timepiece module comprises:
a guide element defined above,
a balance wheel,
a pallet assembly, and
an escapement wheel.

According to the invention, a timepiece movement comprises a timepiece module defined above and/or a guide element defined above.

According to the invention, a timepiece, in particular a wristwatch, comprises:
a guide element defined above, and/or
a timepiece module defined above, and/or
a timepiece movement defined above.

### BRIEF DESCRIPTION OF THE DRAWINGS

The subjects, features and advantages of the present invention are set out in detail in the following description of a particular non-limiting embodiment given with respect to the appended figures.

FIG. 1 is a schematic view of an embodiment of a timepiece according to the invention, an embodiment of a timepiece module according to the invention being shown in detail in a perspective view.

FIG. 2 is a perspective view of the embodiment of the timepiece module according to the invention, the module being assembled on a plate.

### DETAILED DESCRIPTION OF PARTICULAR EMBODIMENTS

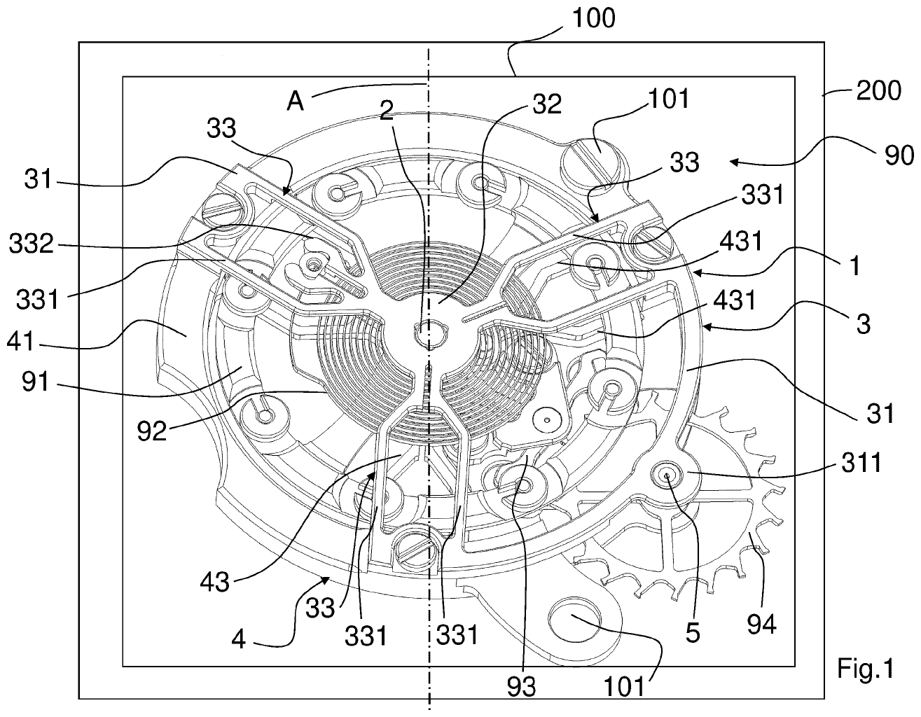

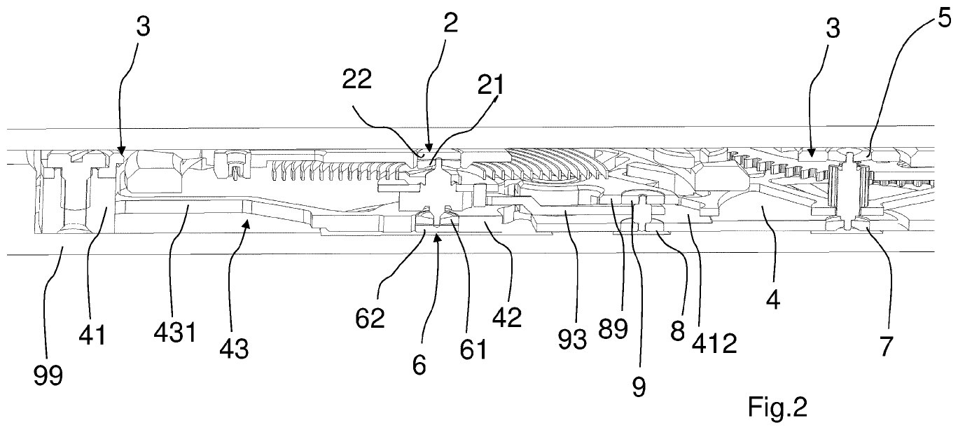

One embodiment of a timepiece 200 is described below in detail with reference to FIGS. 1 and 2. The timepiece 200 is for example a watch, in particular a wristwatch. The timepiece 200 comprises a timepiece movement 100, intended to be mounted in a case or a casing of a timepiece in order to protect it from the external environment. The timepiece movement 100 may be a mechanical movement, in particular an automatic movement.

The movement 100 comprises:
a plate 99, and
a timepiece module 90, in particular an “escapement wheel holder” module which is described in detail below,
   the timepiece module 90 being fitted or mounted on the plate. This mounting can be performed by virtue of screws which pass through holes 101 provided in the module and are screwed in the plate 99.

The timepiece module 90 comprises:
an oscillator comprising a balance wheel 91 and a hairspring 92,
a pallet assembly 93, and
an escapement wheel 94 comprising an escapement cog and an escapement pinion, and
a guide element 1 for guiding the pivoting, about an axis A, of the balance wheel 91.

Advantageously, in the timepiece module the guidance of the pivoting or rotation of the balance wheel, of the pallet assembly and of the escapement wheel is ensured integrally.

The escapement wheel 94 also meshes with a finishing train of the movement 100.

The guide element 1 comprises:
a first guide bearing 2 which does not have a shock absorber, and
a first blank 3, in particular a first balance bar 3 or cock, as shown in the figures.

The first bearing preferably comprises a pivot jewel 21 and an endstone jewel 22. This first bearing is mounted, in particular driven, in a bore provided in the first blank. The first bearing, in particular the aforementioned jewels, is advantageously mounted directly in the first blank. There is no shock absorber between the first bearing (or the jewels of which it is made) and the first blank.

The first blank 3 comprises:
at least one first portion 31 for fixing to another blank 4,
a first receiving portion 32 for receiving the first guide bearing 2, and
at least one first flexible arm 33 mechanically connecting the first fixing portion 31 to the first receiving portion 32.

The at least one first fixing portion advantageously has fixing means for fixing it to a second blank 4. These means may comprise through-holes intended to receive screws screwed in the second blank 4.

In a variant, the first fixing portion may be in the form of a rim. In the variant shown, there are two first fixing portions:
one of the first portions extending overall through approximately 120° about the axis A, and
one of the first portions extending through only a few degrees about the axis A.

These two first fixing portions can be regarded as one and the same discontinuous fixing portion.

Advantageously, the first fixing portion 31 may comprise a first receiving portion 311 for receiving a first guide bearing 5 for the escapement wheel 94. The first guide bearing is for example a jewel driven in a hole made in the first portion 311.

The first receiving portion 32 may have an annular shape surrounding the hole intended to receive the first bearing 2.

With preference, the first receiving portion 32 for receiving the first guide bearing 2 has a thickness of about 0.2 mm or less than 0.23 mm or less than 0.14 mm, this thickness being measured in the direction of the axis A, which is to say generally along the direction of the thickness of the movement.

The at least one first arm is preferably configured and/or designed:
so as to define a stiffness of movement of the first receiving portion of about 8 N/mm or less than 10 N/mm or less than 20 N/mm or less than 50 N/mm or less than 100 N/mm along the direction of the axis A of the guide bearing, and/or
such that the first receiving portion can be moved by more than 0.05 mm or approximately 0.1 mm along the direction of the axis A. This movement may be limited by a watch case element, such as a glass or a back, or by an element of the movement, such as the plate.

The one or more first arms preferably extend substantially radially to the direction of the axis A of the guide bearing.

To obtain such features of flexibility of the first blank, the one or more first arms comprise an open-worked geometry. To produce this open-worked geometry, each arm may comprise two parallel branches 331 extending from the one or more first fixing portions 31. However, these branches come close to one another in the vicinity of the first receiving portion 32 for receiving the guide bearing 2. The branches are parallel again where they meet the first receiving portion 32 for receiving the guide bearing 2. However, they are separated by a narrow slot at this junction.

The geometric data of the arms are, for example, as follows:
the height of the branches (measured parallel to the direction A) ranges for example between 0.14 mm and 0.23 mm,
the width of the branches (measured orthoradially to the direction A) ranges for example between 0.24 mm and 0.25 mm,
the distance between the branches (measured orthoradially to the direction A) ranges for example between 1.4 mm and 1.7 mm,
the width of the slot is for example about 0.1 mm, for example 0.12 mm.

With preference, as in the embodiment shown in FIGS. 1 and 2, the guide element 1 comprises:
a second guide bearing 6 which does not have a shock absorber, and
a second blank 4, in particular a second balance bar or cock, as shown in the figures.

The second bearing preferably comprises a pivot jewel 61 and an endstone jewel 62. This second bearing is mounted, in particular driven, in a bore provided in the second blank 4. The second bearing, in particular the aforementioned jewels, is advantageously mounted directly in the second blank. There is no shock absorber between the second bearing (or the jewels of which it is made) and the second blank.

The second blank 4 comprises:
at least one second portion 41 for fixing to the first blank 3,
a second receiving portion 42 for receiving the second guide bearing 6, and
at least one second flexible arm 43 mechanically connecting the second fixing portion 41 to the second receiving portion 42.

The at least one second fixing portion advantageously has fixing means for fixing it to the first blank 3. These means may comprise screw-feet intended to receive the aforementioned screws. As an alternative, the assembly can be realized by pins for the positioning and by screws for the fixing.

With preference, as in the embodiment shown in the figures, the second fixing portion is preferably in the form of a rim. As an alternative, as on the first blank shown, there may be multiple second fixing portions. These various second fixing portions can be regarded as one and the same discontinuous fixing portion.

Advantageously, the second fixing portion 41 may comprise a second receiving portion 411 for receiving a second guide bearing 7 for the escapement wheel 94. The second guide bearing is for example a jewel driven in a hole made in the second portion 411.

The second receiving portion 42 may have an annular shape surrounding the hole intended to receive the second bearing 6.

With preference, the second receiving portion 42 for receiving the second guide bearing 6 has a thickness of about 0.2 mm or less than 0.23 mm or less than 0.14 mm, this thickness being measured in the direction of the axis A, which is to say generally along the direction of the thickness of the movement.

The at least one second arm is preferably configured and/or designed:
so as to define a stiffness of movement of the second receiving portion of about 8 N/mm or less than 10 N/mm or less than 20 N/mm or less than 50 N/mm or less than 100 N/mm along the direction of the axis A of the guide bearing, and/or
such that the second receiving portion can be moved by more than 0.05 mm or approximately 0.1 mm along the direction of the axis A. This movement may be limited by a watch case element, such as a glass or a back, or by an element of the movement, such as the plate.

The stiffness of movement of the second receiving portion along the direction of the axis A may be equal or substantially equal to the stiffness of movement of the first receiving portion along the direction of the axis A. As an alternative, the stiffness of movement of the second receiving portion along the direction of the axis A and the stiffness of movement of the first receiving portion along the direction of the axis A may be different or substantially different. For example, the stiffness of movement of the second receiving portion along the direction of the axis A may be about three times or four times the stiffness of movement of the first receiving portion along the direction of the axis A.

The one or more second arms preferably extend substantially radially to the direction of the axis A of the guide bearing.

To obtain such features of flexibility of the second blank, the one or more second arms comprise an open-worked geometry. To produce this open-worked geometry, each arm may comprise two parallel branches 431 extending from the one or more second fixing portions 41. However, these branches come close to one another in the vicinity of the second receiving portion 42 for receiving the guide bearing 2. The branches are parallel again where they meet the second receiving portion 42 for receiving the guide bearing 2. However, they are separated by a narrow slot at this junction.

The geometric data of the arms are, for example, as follows:
the height of the branches (measured parallel to the direction A) ranges for example between 0.18 mm and 0.23 mm,
the width of the branches (measured orthoradially to the direction A) ranges for example between 0.14 mm and 0.2 mm,
the distance between the branches (measured orthoradially to the direction A) ranges for example between 1.3 mm and 1.8 mm,
the width of the slot is for example about 0.1 mm, for example 0.12 mm.

Advantageously, the second fixing portion 41 may comprise a second receiving portion 412 for receiving a first guide bearing 8 for the pallet assembly 93. The first guide bearing is for example a jewel driven in a hole made in the second portion 412. A pallet bar 89 may be fixed to the second blank 4 in order to supplement the guidance of the pallet assembly 93. To this end, the pallet bar 89 may comprise a bearing 9.

In the embodiments or variants described, the first blank comprises three arms and the second blank comprises three arms. However, irrespective of the embodiment or the variant:
the first blank may preferably comprise one, two, three or four flexible arms 33, and/or
the second blank may preferably comprise one, two, three or four flexible arms 43.

In general, there may be different, and any, numbers of arms on the first and second blanks. With preference, the number of arms of one and/or the other of the blanks is odd and/or the arms of any pair of arms of one and the same blank are not aligned or oriented in parallel.

Irrespective of the embodiment or the variant, the arms preferably have orthoradial cross sections (relative to the axis A) which are wire-like or of which the greatest ratio of length to width is less than 5 or 3 or 2.

In the embodiments or variants described, the first blank comprises a balance spring stud holder 332 on a first arm. However, irrespective of the embodiment or the variant: the balance spring stud holder may be located on the second blank or on the first blank. This advantageously depends on what side of the balance wheel the hairspring 92 is on.

In the embodiments or variants described, the first and second blanks are bars. These bars together form a guide cage. However, irrespective of the embodiment or the variant, the first blank or the second blank may be a plate.

In the embodiments or variants described, the first and second blanks comprise flexible arms. However, irrespective of the embodiment or the variant, it is possible for only one of the blanks to be provided with flexible arms. For example, the other blank may have a guide bearing mounted in a shock absorber.

In the embodiments or variants described, the first blank may be made for example of a hardenable austenitic superalloy based on cobalt (Phynox) or of copper-beryllium (CuBe).

In the embodiments or variants described, the second blank may be made for example of a hardenable austenitic superalloy based on cobalt (Phynox) or of copper-beryllium (CuBe).

The solutions described above make it possible to realize ultra-flat timepiece movements while at the same time benefiting from a particularly compact balance wheel guiding solution.

As seen above, the geometries of the arms make it possible to ensure a certain flexibility in the guidance of the balance wheel.

1. A guide element for guiding the pivoting, about an axis, of a balance wheel of a timepiece, comprising:
a first guide bearing which does not have a shock absorber, and
a first blank,
the first blank comprising:
at least one first portion for fixing to another blank,
a first receiving portion for receiving the first guide bearing, and
at least one first flexible arm mechanically connecting the first fixing portion to the first receiving portion.

2. The guide element as claimed in claim 1, wherein
the at least one first arm is configured and/or designed so as to define a stiffness of movement of the first receiving portion of less than 100 N/mm along the direction of the axis, and/or
the at least one first arm is configured and/or designed so that the first receiving portion can be moved by more than 0.05 mm along the direction of the axis.

3. The guide element as claimed in claim 1, wherein the guide element comprises multiple first flexible arms mechanically connecting the at least one first fixing portion to the first receiving portion.

4. The guide element as claimed in claim 1, wherein
the one or more first arms comprise an open-worked geometry, and/or
the one or more first arms extend substantially radially to the direction of the axis, and/or
each arm comprises two parallel branches extending from the one or more first fixing portions and coming close to one another in the vicinity of the first receiving portion for receiving the guide bearing.

5. The guide element as claimed in claim 1, wherein
the first fixing portion is in the form of a rim, and/or
the first receiving portion for receiving the first guide bearing has a thickness of less than 0.23 mm along the axis.

6. The guide element as claimed in claim 1, wherein one of the at least one first arms comprises a balance spring stud holder.

7. The guide element as claimed in claim 1, wherein the first fixing portion comprises a first receiving portion for receiving a first guide bearing for an escapement wheel.

8. The guide element as claimed in claim 1, wherein the guide element comprises:
a second guide bearing which does not have a shock absorber, and
a second blank, in particular a second balance bar or a plate,
the second blank comprising:
at least one second portion for fixing to the first blank,
a second receiving portion for receiving the second guide bearing, and
at least one second flexible arm mechanically connecting the at least one second fixing portion to the second receiving portion.

9. The guide element as claimed in claim 8, wherein
the at least one second arm is configured and/or designed so as to define a stiffness of movement of the second receiving portion of less than 100 N/mm along the direction of the axis, and/or
the at least one second arm is configured and/or designed so that the second receiving portion can be moved by more than 0.05 mm along the direction of the axis.

10. The guide element as claimed in claim 8, wherein the guide element comprises multiple second flexible arms mechanically connecting the at least one second fixing portion to the second receiving portion.

11. The guide element as claimed in claim 8, wherein
the one or more second arms comprise an open-worked geometry, and/or
the one or more second arms extend substantially radially to the direction of the axis, and/or
each arm comprises two parallel branches extending from the one or more second fixing portions and coming close to one another in a vicinity of the second receiving portion for receiving the guide bearing.

12. The guide element as claimed in claim 8, wherein
the second fixing portion has a shape of a rim, and/or
the second receiving portion for receiving the second guide bearing has a thickness of less than 0.23 mm along the axis.

13. The guide element as claimed in claim 8, wherein one of the at least one second arms comprises a balance spring stud holder.

14. The guide element as claimed in claim 8, wherein
the at least one second fixing portion comprises a second receiving portion for receiving a guide bearing for an escapement wheel, and/or
the at least one second fixing portion comprises a second receiving portion for receiving a guide bearing for a pallet assembly.

15. A timepiece module comprising:
a guide element as claimed in claim 1,
a balance wheel,
a pallet assembly, and
an escapement wheel.

16. A timepiece movement comprising a guide element as claimed in claim 1.

17. A timepiece comprising a timepiece movement as claimed in claim 16.

18. The guide element as claimed in claim 1, wherein the first blank is a first balance bar or cock.

19. The guide element as claimed in claim 2, wherein the at least one first arm is configured and/or designed so as to define the stiffness of movement of the first receiving portion of less than 50 N/mm along the direction of the axis.

20. The guide element as claimed in claim 3, wherein the guide element comprises from two to four of the first flexible arms.
